(19) United States
(12) Patent Application Publication
(10) Pub. No.: US 2007/0126144 A1
(43) Pub. Date: Jun. 7, 2007

(54) Polish/texture thermoplastic film and method for making the same

(76) Inventors: Yadong Jin, Shanghai (CN); Maria de Jesus Rivera de van Eijndhoven, Bergen op Zoom (NL)

Correspondence Address: CANTOR COLBURN, LLP, 55 GRIFFIN ROAD SOUTH, BLOOMFIELD, CT, 06002, US

(21) Appl. No.: 11/293,687

(22) Filed: Dec. 2, 2005

(51) Int. Cl. B29C 47/00

(52) U.S. Cl. 264/210.2

(57) ABSTRACT

In one embodiment, a method for making a film comprises: heating thermoplastic to above a glass transition temperature of the thermoplastic; passing heated thermoplastic through a die and onto a polished calendaring roll and a resilient calendaring roll, and passing the heated thermoplastic between the polished calendaring roll and the resilient calendaring roll to form the film. The resilient calendaring roll has an average roll surface roughness of about 0.5 μm to about 0.9 μm. A nip pressure between the calendaring rolls is about 100 kPa to about 2,000 kPa. The film has an average film surface roughness of about 0.5 μm to about 0.9 μm, a gloss of less than or equal to about 10, an average stress of less than or equal to about 60 nm, and a stress spread of less than or equal to about 50.

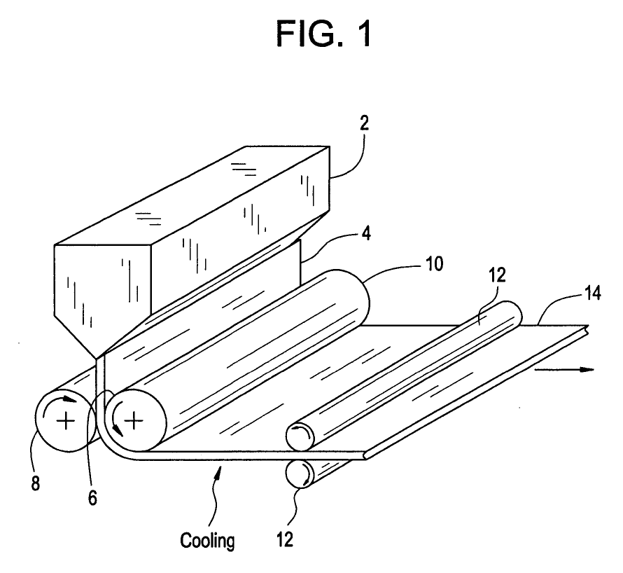

### BACKGROUND

Thermoplastic materials, in particular polycarbonate, can be used as a film in graphical applications that require excellent dimensional stability, good printability and thermoformability. The particular end use application dictates the particularly desired properties of the film. For example, in automotive overlays or instrument clusters polycarbonate film (which can also be referred to as a sheet, layer, foil, and the like) is commonly used, for example, to provide accurate and in some cases tridimensional molded parts, with multicolor graphics that can be backlit. Other applications requiring good scratch or abrasion resistance while maintaining excellent graphics can include high performance labels or flooring graphic applications.

Achieving dimensional stable molded parts with defect free graphic and aesthetics requires the accurate control of film properties. In particular for minimum distortion during thermoforming, a low stress level and stress spread are desired. In addition polished/textured polycarbonate films having controllable low roughness and low gloss in the textured surface is difficult to balance while maintaining as well a low retardation level.

### SUMMARY

Disclosed herein are methods of making polish/textured films, and films made therefrom. In one embodiment, a method for making a film comprises: heating thermoplastic to above a glass transition temperature of the thermoplastic; passing heated thermoplastic through a die and onto a polished calendaring roll and a resilient calendaring roll, and passing the heated thermoplastic between the polished calendaring roll and the resilient calendaring roll to form the film. The resilient calendaring roll has an average roll surface roughness of about 0.5 μm to about 0.9 μm. A nip pressure between the calendaring rolls is about 100 kPa to about 2,000 kPa. The film has an average film surface roughness of about 0.5 μm to about 0.9 μm, a gloss of less than or equal to about 10, an average stress of less than or equal to about 60 nm, and a stress spread of less than or equal to about 50.

The above-described and other features will be appreciated and understood from the following detailed description, drawing, and appended claims.

### BRIEF DESCRIPTION OF THE DRAWINGS

Refer now to the FIGURE, which is exemplary.

The FIGURE is a schematic view of one embodiment of a continuous extrusion system illustrating the extrusion of a thermoplastic melt downward into the nip or gap between two calendering rolls lying in a horizontal plane.

### DETAILED DESCRIPTION

Disclosed herein are thermoplastic films, more particularly polish/texture thermoplastic films capable of being employed in various applications, including graphical applications (e.g., control panels or appliance overlays, and so forth), automotive applications (e.g., automotive instrument clusters and so forth), in multi-layered structures, thermoformed articles, and so forth. It is noted that these graphic films can be a single layer (e.g., a unitary or monolithic film characterized by the absence of coatings) or a multi-layered structure.

Also disclosed herein are processes for making such polish/texture films. In one embodiment, the extrusion process can comprise: feeding a thermoplastic polycarbonate resin to an extruder; heating the resin in the extruder to a melt temperature that is above a glass transition temperature of the resin, thereby producing a melt of the thermoplastic polycarbonate resin; extruding the melted resin downwardly through an extrusion nozzle orifice having a slot configuration (optionally, the slot may be oriented perpendicular to the gap between the calendering rolls (the nip)); passing the melted resin downwardly into a gap between two calendering rolls at least one of which has a highly polished surface, and wherein the calendering rolls are maintained at a roll temperature of less than the glass transition temperature; and cooling the thermoplastic polycarbonate resin film to below its glass transition temperature as the thermoplastic polycarbonate resin film advances through the gap.

In one embodiment, the graphic film can be formed from a thermoplastic (e.g., polycarbonate resin such as Lexan® resin, commercially available from General Electric Company, Schenectady, N.Y.). Possible polycarbonate resins that can be employed in producing the base film, include aromatic polycarbonates, polycarbonate copolymers, and so forth, as well as copolymers comprising at least one of the foregoing, reaction products comprising at least one of the foregoing, and combinations comprising at least one of the foregoing; such as polyester carbonate copolymer. Examples of aromatic polycarbonate resin (in particular aromatic homo-polycarbonate resin) are described in U.S. Pat. No. 4,351,920 to Ariga et al. These polycarbonate resins can be obtained by the reaction of an aromatic dihydroxy compound with a carbonyl chloride. Other possible polycarbonate resins can be obtained by the reaction of an aromatic dihydroxy compound with a carbonate precursor such as a diaryl carbonate. An exemplary aromatic dihydroxy compound is 2,2-bis(4-hydroxy phenyl) propane (i.e., Bisphenol-A). A polyester carbonate copolymer can be obtained by the reaction of a dihydroxy phenol, a carbonate precursor and dicarboxylic acid such as terephthalic acid and/or isophthalic acid. Optionally, an amount of a glycol can also be used as a reactant.

The film can optionally comprise an anti-static material in an amount sufficient to impart anti-static properties to the film. For example, an anti-static material comprising phosphonium sulfonate can be added to a base film comprising polycarbonate. In an embodiment, the anti-static material is that described in U.S. Pat. No. 6,194,497 to Henricus et al. More specifically, the phosphonium sulfonate can be a fluorinated phosphonium sulfonate comprising a fluorocarbon containing an organic sulfonate anion and an organic phosphonium cation. Examples of such organic sulfonate anions include, but are not limited to, perfluoro methane sulfonate, perfluoro butane sulfonate, perfluoro hexane sulfonate, perfluoro heptane sulfonate, and perfluoro octane sulfonate. Examples of the phosphonium cation include, but are not limited to, aliphatic phosphonium (such as tetramethyl phosphonium, tetraethyl phosphonium, tetrabutyl phosphonium, triethylmethyl phosphonium, tributylmethyl phosphonium, tributylethyl phosphonium, trioctylmethyl phosphonium, trimethylbutyl phosphonium, trimethyloctyl phosphonium, trimethyllauryl phosphonium, trimethylstearyl phosphonium, triethyloctyl phosphonium, and so forth), and aromatic phosphoniums (such as tetraphenyl phosphonium, triphenylmethyl phosphonium, triphenylbenzyl phosphonium, tributylbenzyl phosphonium, and so forth). More specifically, the fluorinated phosphonium sulfonate can be obtained by any combination comprising at least one of any of these organic sulfonate anions with phosphonium cations.

Furthermore, even more specifically, the phosphonium sulfonate employed herein can be a fluorinated phosphonium sulfonate having the general formula:
{CF₃(CF₂)n(SO₃)}θ {P(R₁)(R₂)(R₃)(R₄)}Φ
wherein: F is fluorine;
n is an integer of 1 to 12;
S is sulfur;
R₁, R₂, and R₃ can each comprise an aliphatic hydrocarbon radical of 1 to 8 carbon atoms or an aromatic hydrocarbon radical of 6 to 12 carbon atoms; and
R₄ is a hydrocarbon radical of 1 to 18 carbon atoms.

Anti-static compositions comprising fluorinated phosphonium sulfonate shown by formula as having the principle component thereof can be used in many different ways to make use of their anti-static and compatibility characteristics and heat resistance in providing such anti-static characteristics to polycarbonate. The phosphonium fluorocarbon sulfonate salts are low melting semi-solid materials, and as such, they can be handled as a molten liquid. Some embodiments are solid crystalline materials at room temperature (i.e., a temperature of about 15° C. to about 25° C.) and are easy to weigh, handle, and add to the polycarbonate.

While the anti-static material can be added to the polycarbonate at any time in the process, it is desirable to add it to the polycarbonate at the time of polymer production. For example, the polycarbonate and anti-static material can be processed by, for example, extrusion, and the like.

The base films can comprise greater than or equal to about 80 wt. % polycarbonate, and more particularly greater than or equal to about 90 wt. % polycarbonate, wherein weight percents are based on a total weight of the base film. For example, in an embodiment, the base film comprises about 93 wt. % to about 99.6 wt. % polycarbonate; and about 0.4 wt. % to about 7 wt. % anti-static material, and more specifically, about 0.4 wt. % to about 2 wt. % anti-static material.

While it is noted that the thickness of these graphic films can vary depending on the desired application, they can comprise a thickness sufficient for the intended use. For example, these films can comprise a thickness of about 25 micrometers (μm) to about 1,000 micrometers, or, more specifically, about 175 micrometers to about 750 micrometers.

The graphic film also has a low stress retardation level and a low stress spread. A low stress retardation film can be defined mathematically as a film comprising both a low stress retardation average and/or a low stress spread. These quantities can be calculated from the analysis of a stress retardation profile (i.e., stress retardation as a function of location along the width of the film). The stress level can be represented by the average value of the stress profile, whereas stress spread can be defined as the difference between this average and the lowest or highest retardation value measured across the width of the film. For the graphic films described herein, the stress level on the film can be less than or equal to 60 nanometers across the film width, more particularly less than or equal to 40 nanometers across the film width. The stress retardation spread can be less than or equal to 50 nanometers across the film width, more particularly less than or equal to 30 nm across the film width, still more particularly less than or equal to 15 nm across the film width. Stress retardation can be measured using, for example, using a SCA1500 System (commercially available from Strainoptic, Inc., North Wales, Pa.) according to ASTM D4093.

The graphic film can comprise a first surface comprising a textured surface, e.g., a matte surface, and a second surface comprising a polished surface. For example, a polish surface can comprise an average surface roughness (Ra) of less than 0.3 micrometers; a matte (e.g., fine matte, medium matte, course matte, and the like) surface can comprise an average surface roughness (Ra) of 0.3 micrometers to 2.2 micrometers; and a velvet surface can comprise an average surface roughness (Ra) greater than 2.2 micrometers. The roughness is a measure of the average roughness of the film. It can be determined by integrating the absolute value of the difference between the surface height and the average height and dividing by the measurement length for a one dimensional surface profile, or the measurement area for a two dimensional surface profile. Surface roughness can, for example, be measured using a Serfcorder SE4000K, commercially available from Kosaka Laboratory Ltd., Tokyo, Japan, wherein the surface roughness is measured according to ASME B46.1-1995.

In an embodiment, making a graphic film comprises feeding a thermoplastic resin(s) (e.g., polycarbonate resin) to an extruder; melting the thermoplastic resin to a temperature greater than or equal to the glass transition temperature (Tg) of the thermoplastic resin while it advances through the extruder; extruding the resulting molten resin through a die into a nip or gap between two calendering rolls; and cooling the resulting film to below its glass transition temperature. The resulting film can be rolled and stored for subsequent processing (e.g., coating and casting, embossing, and the like). Alternatively, the base film can be feed directly to a coating and casting station, embossing station, and the like.

In an embodiment, the molten thermoplastic resin used to produce the graphic film is passed through two calendering rolls such that the resulting film has a low stress retardation level and variation, comprising a stress level of less than or equal to 60 nm, a stress retardation spread less than or equal to 50 nanometers per inch (nm/in), an average roughness, Ra, of about 0.5 μm to about 0.9 μm, and a gloss of less than 5.0. Gloss is related to the ability of a surface to reflect more light in some directions than in others. A bright light is reflected off a specimen at an angle and the luminance or brightness of the reflected beam is measured by a photodetector. Measured gloss ratings are obtained by comparing the specular reflectance from the specimen to that from a standard. Gloss on the texture surface can be measured as referenced in ASTM D523-60 by black-painting the polish surface and obtaining a gloss measurement by using a BYK Gardner gloss meter on the texture side (commercially available from BYK-Gardner GmbH, Geretsried, Germany). It is noted that the gloss values for the texture side of the films disclosed herein were measured under 60 degree with black back-paint.

One of the calendering rolls can comprise a material comprising a hardness suitable for the graphic film. For example, the roll(s) can comprise an elastomeric material (e.g., an EPDM (ethylene propylene diamine monomer) based rubber). It is noted that in various embodiments the roll can be made entirely of the elastomeric material. Alternatively, the elastomeric material can be disposed on an outer surface of the roll, i.e., the surface of the roll that is in physical communication with the film. For example, in making the graphic film, a textured rubber calendering roll can be employed to texture the first surface of the film, as discussed above (e.g., the surface is a matte surface), and is characterized by a surface roughness, Ra between 0.4 and 0.8 microns

The second surface can have a polished surface, which can be attained with a calendering roll comprising a polished surface, e.g., a metal or metal plated roll. Possible metals include chromium, iron, nickel, aluminum, copper, and so forth, as well as alloys comprising at least one of the foregoing metals, and mixtures comprising at least one of the foregoing metals; e.g., steel (such as stainless steel), ferrous alloys, and so forth.

The FIGURE illustrates an exemplary extrusion system. Molten thermoplastic resin 4 extrudes through slot die 2, passes through a nip or gap 6 formed by calendering rolls 8 and 10, is cooled, and then passes through pull rolls 12. The cooled film can be rolled (stored) to be subsequently processed, or can be directly fed to a station (device) for further processing (e.g., a coating and casting station, embossing station, molding station, thermoforming station, and so forth). For example, at a nip pressure of about 5 bars (500 kilopascals (kPa)) to about 15 bars (1,500 kPa) and a rubber roll temperature of about 25° C. to about 70° C. (as measured from a thermocouple in thermal communication with a heat exchange fluid in the rubber roll), a film having a thickness of about 100 μm to about 1,000 μm or so, can be produced with a Ra of about 0.5 μm to about 0.9 μm (or, more particularly, about 0.5 μm to about 0.7 μm), with a gloss of less than or equal to about 8 (or, more specifically, less than or equal to about 5), with an average stress of less than or equal to about 60 nm (or, more specifically, an average stress of about 30 nm to about 50 nm), with a stress spread of less than or equal to about 20 (or, more specifically, less than or equal to about 15 nm).

For the present process, the nip pressure (Pₙᵢₚ) can be about 2 bars (200 kPa) to about 15 bars (1,500 kPa), or, more specifically, about 5 bars (500 kPa) to about 10 bars (1,000 kPa). The rubber roll temperature (Tᵣᵣ), as measured from a thermocouple in thermal communication with a heat exchange fluid in the rubber roll, can be greater than or equal to about 125° C. less than the glass transition temperature of the thermoplastic resin. For example, the rubber roll temperature can be about 25° C. to about 70° C. Films having a thickness of up to about 1,000 μm, or so, can be produced with this process, or, more specifically, a gage of about 100 μm to about 1,000 μm, or, even more specifically, about 200 μm to about 800 μm. The surface roughness produced is a function of the line speed, roll temperatures, and other factors. However, a surface roughness of about 0.5 μm to about 0.9 μm can be attained (or, more particularly, about 0.5 μm to about 0.7 μm), with a gloss of less than or equal to about 8 (or, more specifically, less than or equal to about 5), with an average stress of less than or equal to about 60 nm (or, more specifically, an average stress of about 30 nm to about 50 nm), with a stress spread of less than or equal to about 50 (or, more specifically, less than or equal to about 20 nm).

The following examples are merely intended to further illustrate the present films and methods for making these films and are not intended to limit the scope hereof.

### EXAMPLES

Polycarbonate films were produced by heating a polycarbonate resin, to temperatures above its glass transition temperature (T_{g} of about 150° C.) to form a melt. The film was made on a pull extrusion line, characterized by a gap between two calendering rolls, which lie in a plane essentially horizontal to the downward extrusion of the resin. The melt was extruded downwards from a slit die perpendicular to the calendaring rolls, while being maintained at a temperature below the glass transition temperature. The melt cooled to below the resin T_{g} as it passed between the rolls. The resultant films had the properties set forth in Table I. The film properties obtained, melt temperatures, rubber roll roughness, and significant process conditions are also shown in Table I. For example purposes, films having different gages are also shown in Table I.

TABLE I

| | Roll | | | | | Film | | Avg. | Stress |
|---|---|---|---|---|---|---|---|---|---|
| | Rₐ | Ln Spd | | Tᵣᵣ | Gage | Rₐ | | Stress | spread |
| Ex. | (μm) | (m/min) | Pₙᵢₚ | (° C.) | (μm) | (μm) | Gloss | (nm) | (nm) |
| 1 | 0.32 | 18 | 10 | 30 | 125 | 0.34 | 10.58 | 32.00 | 28.00 |
| 2 | 0.32 | 22 | 6 | 30 | 125 | 0.36 | 8.42 | 22.34 | 7.00 |
| 3 | 0.95 | 40 | 6 | 30 | 500 | 0.90 | 3.00 | 71.7 | 46 |
| 4 | 0.95 | 53 | 14 | 35 | 500 | 1.01 | 2.37 | 97.8 | 54 |
| 5 | 0.63 | 14.4 | 6 | 30 | 125 | 0.59 | 3.66 | 28 | 9.8 |
| 6 | 0.69 | 6.8 | 10 | 30 | 125 | 0.68 | 2.62 | 33 | 10 |
| 7 | 0.63 | 4.1 | 6 | 30 | 375 | 0.68 | 1.7 | 42.74 | 17.5 |
| 8 | 0.63 | 9.5 | 10 | 30 | 375 | 0.58 | 3.9 | 46.85 | 11.83 |
| 9 | 0.63 | 3.6 | 6 | 30 | 500 | 0.68 | 2.2 | 31 | 12 |
| 10 | 0.63 | 5.4 | 6 | 60 | 500 | 0.58 | 4.7 | 50 | 12 |

Examples 1 and 2 in Table I demonstrate the effect of utilizing a low roughness rubber roll, whereby the resulting film roughness and retardation level are fairly low (e.g., less than 0.4 μm, and less than 35 nm, respectively) but the gloss level is above 8. The effect of the pressure at the nip between the two calendaring rolls can also be seen in these two examples, with a lower nip pressure leading to a decrease in stress retardation level and spread. Conversely, examples 3 and 4 in Table I show the effect of having a rubber roll conditioned to a roughness of 0.95 μm. In ase the film produced using this roll has roughness greater than 0.8 μm (e.g., 0.9 and 1.01 respectively) as well as substantially higher stress retardation level and spread. A similar effect of the nip pressure is shown in these examples, with a lower nip pressure leading to lower values of stress retardation level and spread.

Examples 5 through 10 show the effect of conditioning the rubber roll to a roughness intermediate between those of Examples 1 and 2 and Examples 3 and 4. In these examples it is shown that for various gauges, line speeds, and nip pressures, the film gloss, roughness, and stress retardation level and spread can be maintained below certain levels. The gloss was less than 8, or, more particularly, less than or equal to about 7, or, even more particularly, less than or equal to 5, and yet more particularly, less than or equal to about 4 (for Examples 5-9). Similarly, the film roughness was controlled to be about 0.5 μm to about 0.7 μm. The retardation level and spread were less than or equal to about 50 nm and less than 20 nm, respectively, or, more specifically, less than or equal to about 48 nm and less than 18 nm, respectively (for Examples 5-9).

These examples further support that other processing conditions can be slightly varied while maintaining film properties in a desired range. For graphical film applications, a gloss level of less than or equal to 8, or, more specifically, less than or equal to 5, can be obtained across all gauges. This is particularly useful for graphical displays wherein low roughness allows a better control of the printing quality. The average roughness can be about 0.5 μm to about 0.9 μm, or, more specifically, about 0.5 μm to about 0.7 μm.

For example, these examples show that a film can be produced having a film thickness of about 100 μm to about 600 μm, an average film surface roughness of about 0.5 μm to about 0.75 μm, a gloss of less than or equal to about 4, an average stress of less than or equal to about 50 nm, and a stress spread of less than or equal to about 20. Additionally, a film can be produced using a resilient roll having an average roll surface roughness of about 0.6 μm to about 0.7 μm, wherein the film has a gloss of about 2 to about 3.75, an average stress of about 25 to about 35 nm, and a stress spread of less than or equal to about 15.

It is also desirable to be able to maintain dimensional stability during subsequent process. For example, in thermoforming or in-mold decoration, a graphic film will be exposed to high temperature and/or pressure in order to be shaped into a tridimensional form suitable for the end use. If the stress in the film is substantial, undesirable distortion (e.g., in shape and/or graphics) can be formed in the finished article. Hence, stress retardation levels of less than 50 nm, or more specifically, less than 40 nanometers, yield optimal performance, in combination with the other graphic film properties. Besides the stress retardation level (which represents from the mathematical point of view the average value of the stress across the film width), the stress spread can also affect the final product; maintaining a flat stress profile will ensure equal performance across the film width. The graphic film can have a stress retardation spread of less than or equal 20 nm, or, more specifically, less than or equal to about 15 nm.

Manufacturing a graphic film while combining the elements of dimensional stability and forming properties with the need of excellent graphic and aesthetics typically results in a tradeoff. The resulting film may show an acceptable stress retardation level and spread, and an acceptable roughness, but gloss may be too high. In other cases, it may be possible to produce a film that has acceptable gloss but unacceptable roughness and/or retardation level and/or spread. The above graphic films, however, enable low levels of gloss, roughness and stress retardation level and spread. For example, the a rubber roll roughness as well as processing conditions can lead to such graphic films, with such properties ranges.

Ranges disclosed herein are inclusive and combinable (e.g., ranges of “up to about 25 wt %, or, more specifically, about 5 wt % to about 20 wt %”, is inclusive of the endpoints and all intermediate values of the ranges of “about 5 wt % to about 25 wt %,” etc). Furthermore, the terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item. The modifier “about” used in connection with a quantity is inclusive of the stated value and has the meaning dictated by the context, (e.g., includes the degree of error associated with measurement of the particular quantity). The suffix “(s)” as used herein is intended to include both the singular and the plural of the term that it modifies, thereby including one or more of that term (e.g., the filler(s) includes one or more fillers).

While the invention has been described with reference to several embodiments thereof, it will be understood by those skilled in the art that various changes can be made and equivalents can be substituted for elements thereof without departing from the scope of the invention. In addition, many modifications can be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the appended claims.

What is claimed is:

1. A method for making a film, comprising:
heating thermoplastic to above a glass transition temperature of the thermoplastic;
passing heated thermoplastic through a die and onto a polished calendaring roll and a resilient calendaring roll, wherein the resilient calendaring roll has an average roll surface roughness of about 0.5 μm to about 0.9 μm; and
passing the heated thermoplastic between the polished calendaring roll and the resilient calendaring roll to form the film, wherein a nip pressure between the calendaring rolls is about 200 kPa to about 1,500 kPa, and wherein the resilient calendering roll and the polished calendaring roll have a roll temperature of greater than or equal to about 125° C. less than the glass transition temperature;
wherein the film has a film thickness of about 100 μm to about 1,000 μm, an average film surface roughness of about 0.5 μm to about 0.9 μm, a gloss of less than or equal to about 8, an average stress of less than or equal to about 60 nm, and a stress spread of less than or equal to about 50.

2. The method of claim 1, wherein the roll temperature is about 25° C. to about 70° C.

3. The method of claim 1, wherein the nip pressure is 500 kPa to about 1,000 kPa.

4. The method of claim 1, wherein the film thickness is about 200 μm to about 800 μm.

5. The method of claim 1, wherein the film surface roughness is about 0.5 μm to about 0.7 μm.

6. The method of claim 1, wherein the gloss is less than or equal to about 5.

7. The method of claim 1, wherein the average stress is about 30 nm to about 50 nm.

8. The method of claim 1, wherein the stress spread is less than or equal to about 20 nm.

9. The method of claim 1, wherein the die is a slot die that is oriented perpendicular to the nip.

10. The method of claim 1, wherein the film thickness is about 100 μm to about 600 μm, the average film surface roughness of about 0.5 μm to about 0.75 μm, the gloss is less than or equal to about 4, the average stress is less than or equal to about 50 nm, and the stress spread is less than or equal to about 20 nm.

11. The method of claim 10, wherein the average roll surface roughness is about 0.6 μm to about 0.7 μm, and wherein the gloss is about 2 to about 3.75, the average stress is about 25 to about 35 nm, and the stress spread is less than or equal to about 15 nm.

12. The method of claim 1, wherein the thermoplastic comprises polycarbonate.

13. A film produced from the method of claim 1.

14. An article formed by thermoforming the film of claim 13.

15. A film produced from the method of claim 10.

16. A method for making a film, comprising:
heating thermoplastic, wherein the thermoplastic comprises polycarbonate;
passing heated thermoplastic through a die and onto a polished calendaring roll and a resilient calendaring roll, wherein the resilient calendaring roll has an average roll surface roughness of about 0.5 μm to about 0.9 μm; and
passing the heated thermoplastic between the polished calendaring roll and the resilient calendaring roll to form the film, wherein a nip pressure between the calendaring rolls is about 500 kPa to about 1,000 kPa, and wherein the resilient calendering roll and the polished calendaring roll have a roll temperature of about 20° C. to about 50° C.;
wherein the film has an average film surface roughness of about 0.5 μm to about 0.9 μm, a gloss of less than or equal to about 8, an average stress of less than or equal to about 60 nm, and a stress spread of less than or equal to about 30.
